(19) United States
(12) Patent Application Publication
(10) Pub. No.: US 2015/0220306 A1
(43) Pub. Date: Aug. 6, 2015

(54) CALCULATION PROGRAM, CALCULATION DEVICE, AND CALCULATION METHOD

(71) Applicant: FUJITSU LIMITED, Kawasaki-shi (JP)

(72) Inventors: Izuho Minaki, Mishima (JP); Masaki Nishigaki, Kobe (JP); Naohiro Itou, Numazu (JP); Kokichi Sugiyama, Numazu (JP); Tatsuya Yamamoto, Fuji (JP); Asami Hasegawa, Numazu (JP)

(21) Appl. No.: 14/602,573

(22) Filed: Jan. 22, 2015

(30) Foreign Application Priority Data
Jan. 31, 2014 (JP) 2014-017265

(51) Int. Cl. G06F 7/50; H04L 29/08; G06F 7/52

(52) U.S. Cl. CPC G06F 7/50; G06F 7/52; H04L 67/10

(57) ABSTRACT

A computer-readable recording medium having stored therein a calculation program causing a computer to execute a process includes: dividing each of subtracted value data and subtraction value data into a plurality pieces of data in a byte; comparing sizes of each of the divided pieces of subtracted value data and each of the divided pieces of subtraction value data, which have a corresponding digit position; adding carry-down value data that is obtained from digit information of each of the divided pieces of subtracted value data, to the divided corresponding piece of subtracted value data, in accordance with a comparison result; and subtracting each of the divided pieces of subtraction value data, from the divided piece of subtracted value data, to which the carry-down value data is add, and which has the corresponding digit position.

### CROSS-REFERENCE TO RELATED APPLICATION

This application is based upon and claims the benefit of priority of the prior Japanese Patent Application No. 2014-017265 filed on Jan. 31, 2014, the entire contents of which are incorporated herein by reference.

### FIELD

The embodiments discussed herein are related to a calculation program, a calculation device, and a calculation method.

### BACKGROUND

In a database system, a fast and convenient data operation is desired, and a data format is defined internally using the concept of “data-type” that is compatible with the form of data that is used by a user to achieve processing such as storage of data in a disk, and comparison and calculation of pieces of data. The data-type includes, for example, a type in which a date and time is processed, a type in which a numeric value is processed, and a type in which a character is processed.

As a related art, there is a technology in which, when an event occurs, date-and-time conversion operation is performed on an event record to convert the event record into a conversion record and store the conversion record in a history information database using a reference date and time and an occurrence date and time so that an obtained calculation result becomes small as the occurrence date and time becomes later.

Japanese Laid-open Patent Publication No. 2006-146509 is the related art.

However, in the related art, it takes a long time to execute subtraction processing of data in which a range of values to be obtained is different depending on a digit position such as data that indicates a date and time. For example, in the case where the range is different depending on each digit position, when carry-down occurs in subtraction of pieces of data, carry-down processing for the digit position is desired. In this case, for example, the architecture of an OS is not allowed to be used as is, and the processing is handled on software side, so that a processing time that is taken for the subtraction processing is increased.

### SUMMARY

According to an aspect of the invention, a computer-readable recording medium having stored therein a calculation program causing a computer to execute a process includes: dividing each of subtracted value data and subtraction value data into a plurality pieces of data in a byte; comparing sizes of each of the divided pieces of subtracted value data and each of the divided pieces of subtraction value data, which have a corresponding digit position; adding carry-down value data that is obtained from digit information of each of the divided pieces of subtracted value data, to the divided corresponding piece of subtracted value data, in accordance with a comparison result; and subtracting each of the divided pieces of subtraction value data, from the divided piece of subtracted value data, to which the carry-down value data is add, and which has the corresponding digit position.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a calculation method according to an embodiment;

FIG. 2 is a diagram illustrating a system configuration example of a database system;

FIG. 3 is a block diagram illustrating a hardware configuration example of a database server;

FIG. 4 is a block diagram illustrating a functional configuration example of the database server;

FIG. 5 is a diagram illustrating the outline of an SIMD COMPARE instruction;

FIG. 6 is a diagram illustrating a data format of TIMESTAMP-type data;

FIG. 7 is a first diagram illustrating a calculation processing example of the TIMESTAMP-type data;

FIG. 8 is a second diagram illustrating the calculation processing example of the TIMESTAMP-type data;

FIG. 9 is a third diagram illustrating the calculation processing example of the TIMESTAMP-type data;

FIG. 10 is a fourth diagram illustrating the calculation processing example of the TIMESTAMP-type data;

FIG. 11 is a fifth diagram illustrating the calculation processing example of the TIMESTAMP-type data;

FIG. 12 is a diagram illustrating a data format of TIME-type data;

FIG. 13 is a first diagram illustrating a calculation processing example of the TIME-type data;

FIG. 14 is a second diagram illustrating the calculation processing example of the TIME-type data;

FIG. 15 is a third diagram illustrating the calculation processing example of the TIME-type data;

FIG. 16 is a fourth diagram illustrating the calculation processing example of the TIME-type data;

FIG. 17 is a fifth diagram illustrating the calculation processing example of the TIME-type data;

FIG. 18 is a diagram illustrating a data format of DATE-type data;

FIG. 19 is a first diagram illustrating a calculation processing example of the DATE-type data;

FIG. 20 is a second diagram illustrating the calculation processing example of the DATE-type data;

FIG. 21 is a third diagram illustrating the calculation processing example of the DATE-type data;

FIG. 22 is a fourth diagram illustrating the calculation processing example of the DATE-type data;

FIG. 23 is a fifth diagram illustrating the calculation processing example of the DATE-type data;

FIG. 24 is a first flowchart illustrating an example of a calculation processing procedure of the database server; and

FIG. 25 is a second flowchart illustrating the example of the calculation processing procedure of the database server.

### DESCRIPTION OF EMBODIMENTS

The embodiments that are related to a calculation program, a calculation device and a calculation method are described in detail with reference to drawings.

### (Example of a Calculation Method)

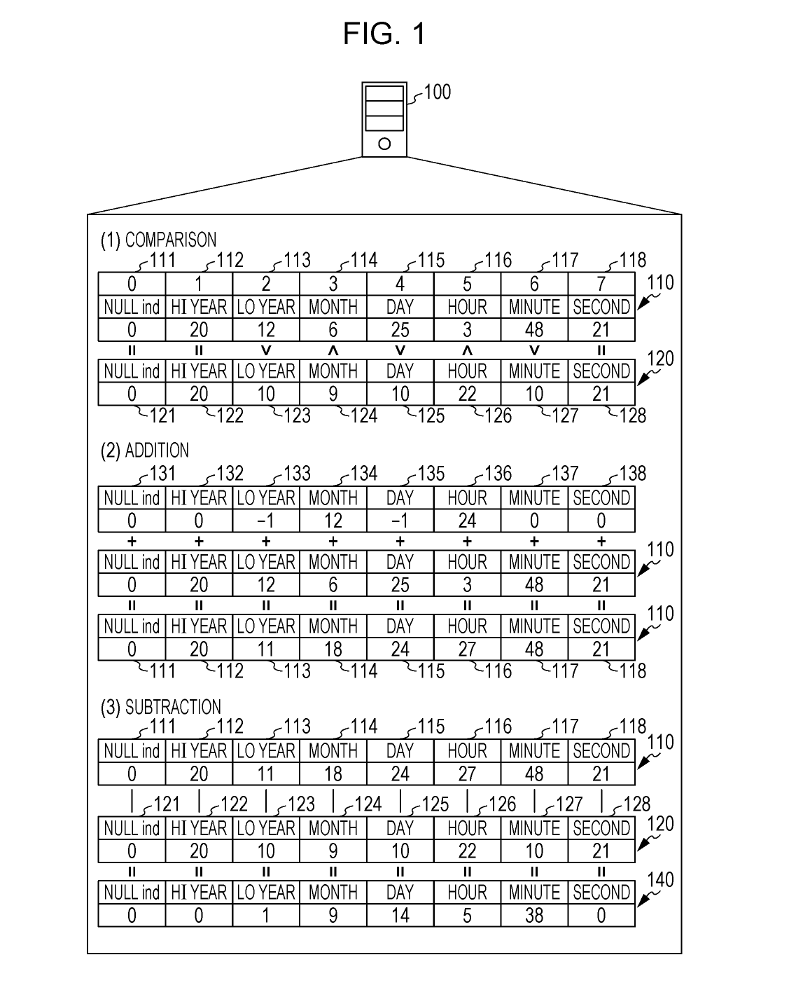

FIG. 1 is a diagram illustrating an example of a calculation method according to an embodiment. In FIG. 1, a calculation device 100 is a computer that subtracts a subtraction value data from a subtracted value data. Here, the subtracted value data means data that is a value to be subtracted. The subtraction value data means data that is a subtracting value.

Each of the subtracted value data and the subtraction value data is data that indicates a date and time, and in the data, pieces of data that indicate numbers having different meanings are arranged. For example, each of the subtracted value data and the subtraction value data includes TIMESTAMP-type data, TIME-type data, DATE-type data, and the like.

In the TIMESTAMP-type data, pieces of data are arranged that respectively indicate “year”, “month”, “day”, “hour”, “minute”, and “second”. In the TIME-type data, pieces of data are arranged that respectively indicate “hour”, “minute”, and “second”. In the DATE-type data, pieces of data are arranged that respectively indicate “year”, “month”, and “day”.

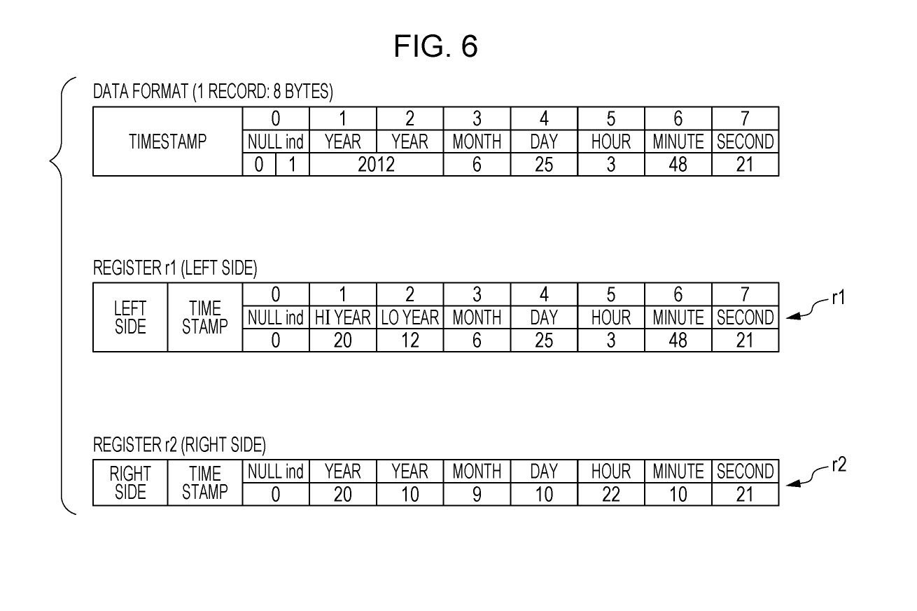

The data formats of the TIMESTAMP-type data, the TIME-type data, and the DATE-type data are described in detail later using FIGS. 6, 12, and 18.

As a specific example of the subtracted value data, for example, there is data that indicates an expiration date and time of a food product. As a specific example of the subtraction value data, for example, there is data that indicates a manufacturing date and time of the product. In this case, by subtracting the subtraction value data from the subtracted value data, a date-and-time gap between the expiration date and time and the manufacturing date and time is obtained, and for example, the obtained date-and-time gap may be useful to determine a product that is to be discounted, a product that is to be removed from shelves, and the like.

Here, in data that indicates a date and time, the range of values is different depending on a digit position. The digit position indicates the position of arranged data. Therefore, in the subtraction processing of the data that indicates a date and time, carry-down processing at each digit position is desired. In the carry-down, in a case where a subtracted value in a certain digit position is smaller than the corresponding subtracting value, when the number of values that are to be obtained as a value of the digit position is added to the subtracted value, a value of the adjacent higher digit position is reduced by 1.

When the TIMESTAMP-type data is used as an example, data that indicates “hour” has the range of “0 to 23”. Therefore, when “14” is subtracted from “12”, “1 day” is carried down from data that indicates “day” in the higher digit position (“1” is subtracted from the data of “day”), and “1 (day)×24 (hours)+12 (hours)−14 (hours)=22 (hours)” is calculated. On the other hand, data that indicates “minute” has the range of “0 to 59”, so that different processing from the data that indicates “hour” is executed.

As described above, in the subtraction processing of data that indicates a date and time, carry-down processing at each digit position is desired, so that the architecture of an OS is not allowed to be used as is, and the processing is handled on software side. However, for example, when the size comparison is repeatedly performed for each of the digit positions of the data indicating a date and time, and subtraction and addition that are associated with the carry-down are repeatedly performed, the number of steps desired for the subtraction processing of the data is increased.

Therefore, in the embodiment, the calculation device 100 divides each of the subtracted value data and the subtraction value data in a plurality pieces of data in a byte, and performs size comparison on each of the divided pieces of subtracted value data and each of the divided pieces of subtraction value data, which have a corresponding digit position, at once. As a result, the number of processing steps that are desired for the size comparison at each of the digit positions of pieces of data that indicates a date and time is reduced, and carry-down processing and subtraction processing that correspond to each of the digit positions are allowed to be executed in parallel, so that the speed-up of the subtraction processing of data indicating a date and time is achieved. A calculation processing example of the calculation device 100 is described below.

(1) The calculation device 100 compares the sizes of a subtracted value data 110 and a subtraction value data 120 in a byte. Here, the subtracted value data 110 and the subtraction value data 120 correspond to TIMESTAMP-type data having 8 bytes. The TIMESTAMP-type data is data in which pieces of data in a byte, which respectively indicate “year”, “month”, “day”, “hour”, “minute”, and “second”, are arranged.

To further described in detail, the 0th byte of each of the subtracted value data 110 and the subtraction value data 120 indicates “NULL ind”. “NULL ind” is information that is used to identify whether or not the data is indefinite. It is indicated that the data is not indefinite when the NULL ind is “0”, and the data is indefinite when the NULL ind is “1”.

In addition, the first byte and the second byte indicate “year”. Here, “year” is represented by AD, so that the first byte indicates “HI year (higher two digits of the year)”, and the second byte indicates “LO year (lower two digits of the year)”. The third byte indicates “month”. The fourth byte indicates “day”. The fifth byte indicates “hour”. The sixth byte indicates “minute”. The seventh byte indicates “second”.

For example, the calculation device 100 divides each of the subtracted value data 110 and the subtraction value data 120 into a plurality of pieces of data in a byte. In the example of FIG. 1, the subtracted value data 110 is divided into pieces of data 111 to 118 in a byte. In addition, the subtraction value data 120 is divided into pieces of data 121 to 128 in a byte.

In addition, the calculation device 100 respectively compares the sizes of the pieces of data 111 to 118, with the pieces of data 121 to 128 having the corresponding digit position. For example, the calculation device 100 respectively compares the sizes of the pieces of data 111 to 118 and the pieces of data 121 to 128 having the corresponding digit position, at once, by a single instruction multiple data (SIMD) COMPARE instruction.

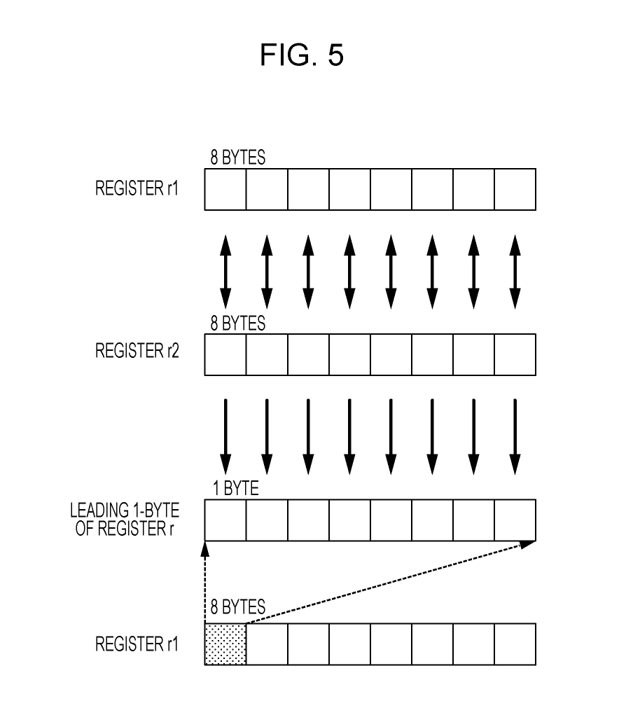

Here, the SIMD COMPARE instruction is used to execute comparison processing of a plurality of pieces of data by a single instruction at the same time. Due to the SIMD COMPARE instruction, the comparison processing of a plurality of pieces of data is executed by a single instruction, and the improvement of the processing performance may be achieved. The SIMD COMPARE instruction is described in detail later with reference to FIG. 5.

(2) The calculation device 100 respectively adds pieces of carry-down value data 131 to 138 that are determined based on pieces of digit information of the pieces of data 111 to 118, to the pieces of data 111 to 118 in accordance with the comparison result. Here, the digit information indicates the ranges of values that are to be obtained as the values of a digit position that corresponds to each of the pieces of data 111 to 118.

For example, the range of values that are to be obtained as the value of the digit position 1 corresponding to the data 112 is “0 to 99”. In addition, the range of values that are to be obtained as the value of the digit position 3 corresponding to the data 114 is “1 to 12”. In addition, the range of values that are to be obtained as the value of the digit position 6 corresponding to the data 117 is “0 to 59”.

For example, the calculation device 100 generates the pieces of carry-down value data 131 to 138 that are used to add the number of values to be obtained as the value of a digit position in which one of the pieces of data 121 to 128 is larger than the corresponding pieces of data 111 to 118, to the value of the digit position, depending on the digit position, and subtract “1” from a value of the higher digit position that is adjacent to the digit position.

In the example of FIG. 1, the data 124 is larger than the data 114. Here, the range of values of the digit position 3 corresponding to the data 114 is “1 to 12”, and the number of values to be obtained as the value of the digit position 3 is “12”. Therefore, the calculation device 100 generates the carry-down value data 134 that is used to add “12” to the value of the digit position 3 corresponding to the data 114, with reference to the digit information. In addition, the calculation device 100 generates the carry-down value data 133 that is used to subtract “1” from the value of the higher digit position 2 that is adjacent to the digit position 3 corresponding to the data 114.

In addition, the data 126 is larger than the data 116. Here, the range of values of the digit position 5 corresponding to the data 116 is “0 to 23”, and the number of values to be obtained as the value of the digit position 5 is “24”. Therefore, the calculation device 100 generates the carry-down value data 136 that is used to add “24” to the value of the digit position 5 corresponding to the data 116, in accordance with the digit information. In addition, the calculation device 100 generates the carry-down value data 135 that is used to subtract “1” from the value of the higher digit position 4 that is adjacent to the digit position 5 corresponding to the data 116.

In addition, the calculation device 100 generates the pieces of carry-down value data 131, 132, 137, and 138 that are respectively used to add “0” to the digit positions 0, 1, 6, and 7 that are different from the digit positions 3 and 5, and the higher digit positions 2 and 4 that are respectively adjacent to the digit positions 3 and 5.

In addition, the calculation device 100 respectively adds the generated pieces of carry-down value data 131 to 138, to the pieces of data 111 to 118 having the corresponding digit positions. In the example of FIG. 1, for example, the carry-down value data 133 is added to the data 113, and “LO year” becomes “11”. In addition, for example, the carry-down value data 134 is added to the data 114, and “month” becomes “18”.

(3) The calculation device 100 respectively subtracts the pieces of data 121 to 128 from the pieces of data 111 to 118 to which the pieces of carry-down value data 131 to 138 having the corresponding digit positions are added. In addition, the calculation device 100 combines the results obtained by performing the subtraction in a byte. As a result, the time gap data 140 is obtained that indicates the result obtained by subtracting the subtraction value data 120 from the subtracted value data 110.

As described above, in the calculation device 100 according to the embodiment, the sizes of the pieces of subtracted value data that are divided in a byte and the sizes of the pieces of subtraction value data that are divided in a byte, which have respective corresponding digit positions may be compared with each other. As a result, the number of processing steps desired for the size comparison of the digit positions of the pieces of data that indicates a date and time may be reduced to “1”. In addition, the carry-down processing and the subtraction processing of each of the digit positions may be executed in parallel, in accordance with the comparison result in a byte.

As described above, in the calculation device 100, the speed-up of the subtraction processing of data in which the range of values are to be obtained is different depending on a digit position such as data that indicates a date and time may be achieved.

### (System Configuration Example of the Database System 200)

A system configuration example of the database system 200 according to the embodiment is described below. Here, an example in which the calculation device 100 illustrated in FIG. 1 is applied to the database server 201 in the database system 200 is described as an example.

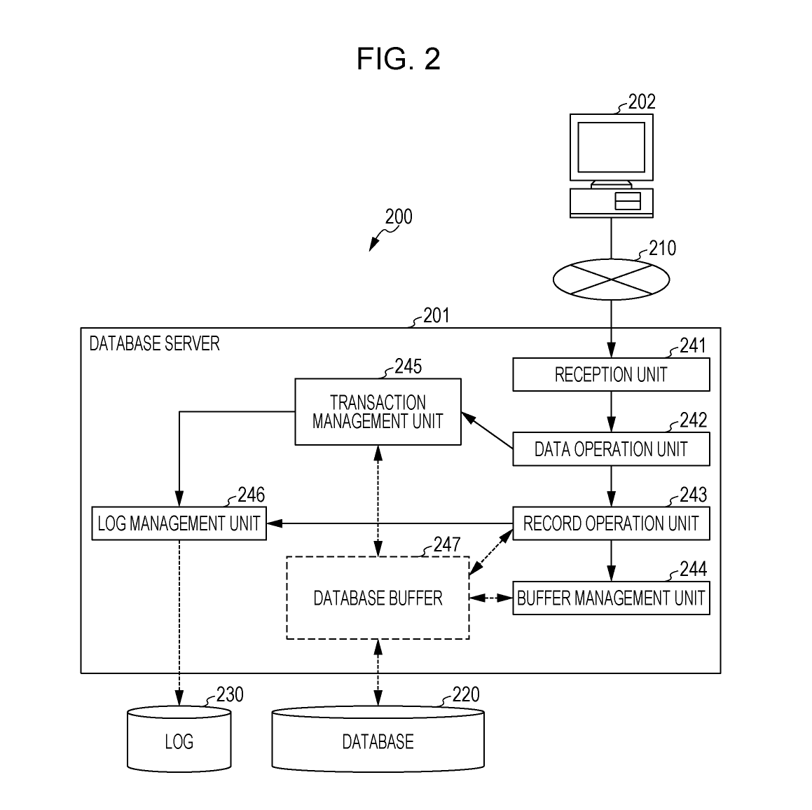

FIG. 2 is a diagram illustrating the system configuration example of the database system 200. In FIG. 2, the database system 200 includes the database server 201 and a client device 202. In the database system 200, the database server 201 and the client device 202 are connected to each other through a wired or wireless network 210. The network 210 is, for example, a local area network (LAN), a wide area network (WAN), the Internet, a mobile communication network, or the like.

The database server 201 is a computer that is allowed to access a database 220 and a log 230. The database 220 stores data that is shared among a plurality of applications and users. The log 230 stores update information of a transaction. The log 230 is used for recover the database 220, for example, when an abnormality such as system down occurs.

The client device 202 is a computer that is used by the user of the database system 200. The client device 202 executes a search request or an update request to the database 220, for the database server 201. For example, the client device 202 is a personal computer (PC), a laptop PC, a tablet-type PC, a smartphone, or the like.

Here, the database server 201 includes a reception unit 241, a data operation unit 242, a record operation unit 243, a buffer management unit 244, a transaction management unit 245, a log management unit 246, and a database buffer 247.

The reception unit 241 accepts a search request or an update request from the client device 202. The data operation unit 242 interprets a data operation instruction that corresponds to the search request or update request that has been accepted by the reception unit 241, with reference to database definition information, and executes the data operation instruction. The record operation unit 243 performs search and update of the database 220, and collection of logs.

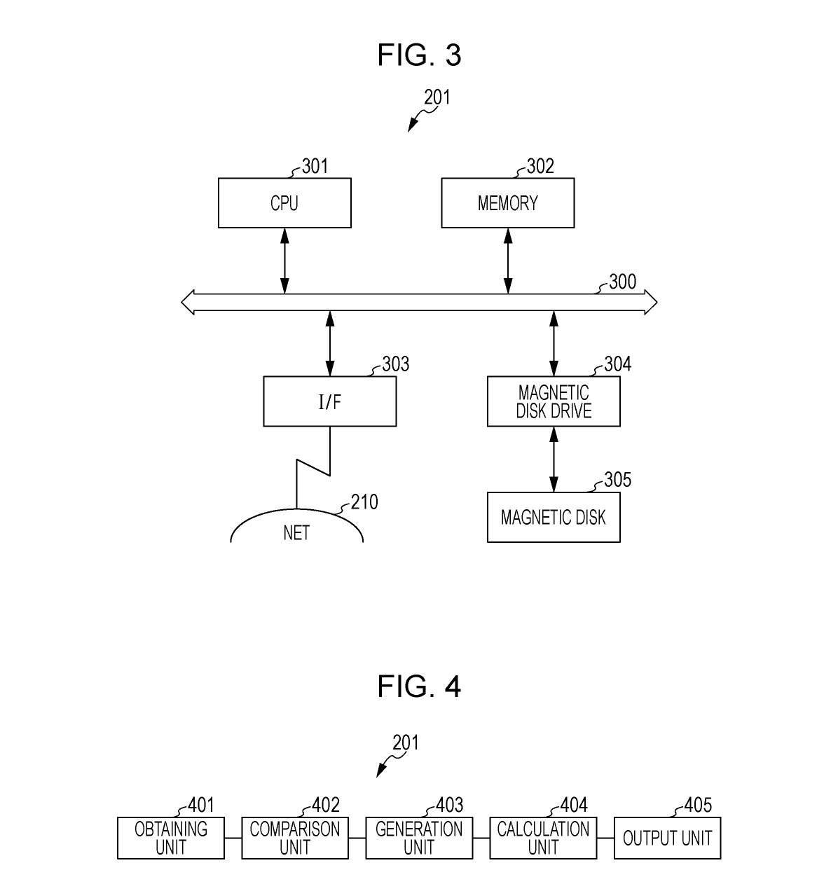

The buffer management unit 244 returns information of the database buffer 247 including a record that has been requested by the record operation unit 243. When the target record does not exist on the database buffer 247, the buffer management unit 244 reads the corresponding data from the database 22, and deploys the read data on the database buffer 247. The database buffer 247 is achieved, for example, by a memory 302 illustrated in FIG. 3, which is described later.

The transaction management unit 245 manages a transaction. When the transaction is settled, the transaction management unit 245 writes the update data on the database buffer 247, to the database 220. On the other hand, when the transaction is cancelled, the transaction management unit 245 disables the updated data on the database buffer 247. The log management unit 246 records the update information of the transaction, to the log 230.

### (Hardware Configuration Example of the Database Server 201)

FIG. 3 is a block diagram illustrating a hardware configuration example of the database server 201. In FIG. 3, the database server 201 includes a central processing unit (CPU) 301, the memory 302, an interface (I/F) 303, a magnetic disk drive 304, and a magnetic disk 305. In addition, the configuration units are connected to each other through a bus 300.

Here, the CPU 301 is responsible for the whole database server 201. The memory 302 includes, for example, a read only memory (ROM), a random access memory (RAM), and a flash ROM. For example, the flash ROM and the ROM stores various programs, and the RAM is used as a work area of the CPU 301. When the program that is stored in the memory 302 is loaded to the CPU 301, the program causes the CPU 301 to execute the coded processing.

The I/F 303 is connected to the network 210 through a communication line, and is connected to a further computer (for example, the client device 202 illustrated in FIG. 2) through the network 210. In addition, the I/F 303 is responsible for an interface between the network 210 and the database server 201, and controls input and output of data from and to a further computer. As the I/F 303, for example, a modem, a LAN adapter, or the like may be used.

The magnetic disk drive 304 controls read/write of data to the magnetic disk 305, in accordance with the control of the CPU 301. The magnetic disk 305 stores data that has been written by the control of the magnetic disk drive 304.

The database server 201 may include, for example, a solid state drive (SSD), a keyboard, a mouse, and a display in addition to the above-described configuration units. In addition, the client device 202 illustrated in FIG. 2 may also be achieved by a hardware configuration example that is similar to that of the above-described database server 201.

### (Functional Configuration Example of the Database Server 201)

FIG. 4 is a block diagram illustrating a functional configuration example of the database server 201. In FIG. 4, the database server 201 includes an obtaining unit 401, a comparison unit 402, a generation unit 403, a calculation unit 404, and an output unit 405. For example, the function of each of the function units is achieved by causing the CPU 301 to execute a program that is stored in the storage device such as the memory 302 and the magnetic disk 305 illustrated in FIG. 3, or by the I/F 303. In addition, each of the function units may be achieved, for example, by hardware. For example, each of the function units may be formed of an element such as AND that is logical conjunction, INVERTER that is logical negation, OR that is logical disjunction, NOR that is logical NOR, and a flip flop (FF) that is a latch circuit. The processing result of each of the function units is stored, for example, in the storage device such as the memory 302 and the magnetic disk 305.

The obtaining unit 401 obtains subtracted value data and subtraction value data. Here, each of the subtracted value data and the subtraction value data is, for example, data of 8 bytes, which includes a record that has been stored in the database 220 (see FIG. 2). For example, the obtaining unit 401 obtains subtracted value data and subtraction value data, from data that has been read to the database buffer 247 (see FIG. 2).

The comparison unit 402 compares the sizes of the subtracted value data and the subtraction value data in a byte. For example, the comparison unit 402 sets the subtracted value data to a register r1. In addition, the comparison unit 402 sets the subtraction value data to a register r2. The register r$ is a storage device of 8 bytes, which is provided in the CPU 301 ($=1, 2, . . . ).

After that, the comparison unit 402 divides each of the subtracted value data and the subtraction value data that have been respectively set to the registers r1 and r2, into a plurality pieces of data in a byte. In addition, the comparison unit 402 compares the sizes of the divided pieces of subtracted value data and the divided pieces of subtraction value data, which have the respective corresponding digit positions, at once, by the SIMD COMPARE instruction.

In the following description, data that corresponds to a digit position # from among the divided pieces of subtracted value data may be referred to as “data a#” (#=0, 1, . . . and, 7). In addition, data that corresponds to the digit position # from among the divided pieces of subtraction value data may be referred to as “data b#”.

The generation unit 403 generates carry-down value data c# that is obtained from the digit information of the divided piece of data a#, in accordance with the comparison result. Here, the digit information is information that indicates the range of values that are to be obtained as the value of the digit position # that corresponds to the data a#, and for example, corresponds to a date-and-time conversion mask and a time conversion mask that are described later. The digit information is stored, for example, in the memory 302 so as to be associated with the data type of the subtracted value data and the subtraction value data.

For example, the generation unit 403 generates carry-down addition value data d# that is used to add the number of values that are to be obtained as the value of a digit position # in which the data b# is larger than the data a#, to the value of the digit position #, in accordance with the digit position #. In addition, the generation unit 403 generates carry-down subtraction value data e (#−1) that is used to subtract “1” from a value of the higher digit position (#−1) that is adjacent to the digit position # in which the data b# is larger than the data a#, in accordance with the digit position #.

In addition, the generation unit 403 generates the carry-down value data c# by combining the carry-down addition value data d# and the carry-down subtraction value data e# that have the corresponding digit position #. As a result, the carry-down value data c# may be generated that is used to add the number of values that are to be obtained as the value of a digit position # in which the data b# is larger than the data a#, to the value of digit position #, and to subtract “1” from the value of the higher digit position (#−1).

The calculation unit 404 adds the generated carry-down value data c to the data a# having the corresponding digit position #. In addition, the calculation unit 404 subtracts the data b# having the corresponding digit position #, from the data a# to which the carry-down value data c# has been added.

The output unit 405 performs output of the calculation result. For example, the output unit 405 performs output of the calculation result that is obtained by subtracting the data b# from the data a# to which the carry-down value data c# has been added. As a result, the data may be obtained that indicates a time gap between the subtracted value data and the subtraction value data.

There are the output formats of the output unit 405 such as storage to the storage device such as the memory 302 and the magnetic disk 305, transmission to an external computer by the I/F 303, display on a display that is not illustrated, and print output to a printer that is not illustrated.

### (SIMD COMPARE Instruction)

The SIMD COMPARE instruction is described below.

FIG. 5 is a diagram illustrating the outline of the SIMD COMPARE instruction. In FIG. 5, the register r1 is a register that is configured by 8 bytes, and stores one of pieces data that are comparison targets. The register r2 is a register that is configured by 8 bytes, and stores the other data that is the comparison target.

When the SIMD COMPARE instruction is applied to the register r1 and the register r2, the data of the register r1 and the data of the register r2 are compared with each other in a byte at once, the comparison result in a byte is stored in the leading 1-byte area of the register r. As described above, due to the SIMD COMPARE instruction, the comparison processing of a plurality of pieces of data may be executed at once by a single instruction, so that the improvement of the processing performance may be achieved.

### (Calculation Processing Example of TIMESTAMP-Type Data)

A calculation processing example of the database server 201 when the subtracted value data and the subtraction value data correspond to TIMESTAMP-type data is described below with reference to FIGS. 6 to 11. First, the data format of the TIMESTAMP-type data when internal processing is executed in the database server 201 is described.

FIG. 6 is a diagram illustrating the data format of the TIMESTAMP-type data. In FIG. 6, the TIMESTAMP-type data includes fields of “NULL ind”, “year”, “month”, “day”, “hour”, “minute”, and “second”, and is data in which a single record is 8 bytes.

Here, the data of the 0th byte in the TIMESTAMP-type data indicates “NULL ind”. The data of the first byte indicates “HI year”. The data of the second byte is indicates “LO year”. The data of the third byte indicates “month”. The data of the fourth byte indicates “day”. The data of the fifth byte indicates “hour”. The data of the sixth byte indicates “minute”. The data of the seventh byte indicates “second”.

In the example of FIG. 6, as the subtracted value data of the TIMESTAMP-type, a bit sequence that indicates “03:48:21 on 25th of Jun. 2012” is set to the register r1. In addition, as the subtraction value data of the TIMESTAMP-type, a bit sequence that indicates “22:10:21: on 10th of Sep. 2010” is set to the register r2.

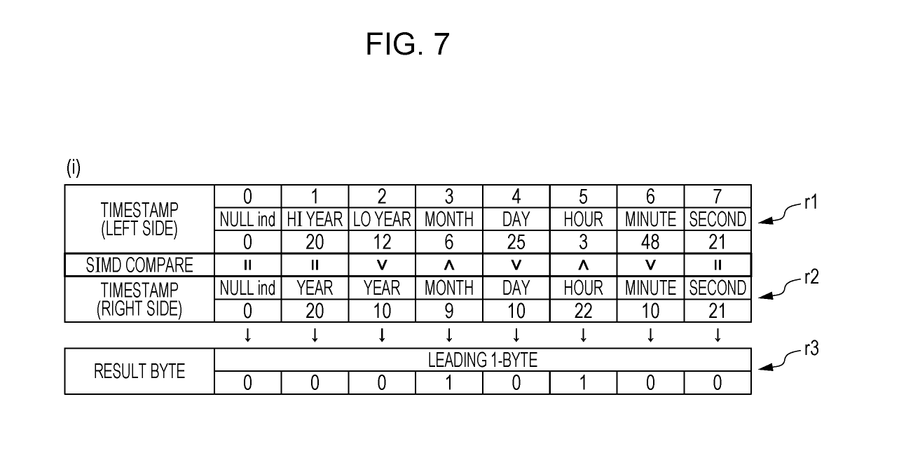

FIGS. 7 to 11 are diagrams illustrating a calculation processing example of the TIMESTAMP-type data. Here, it is assumed that the subtraction value data on the right side, which has been set to the register r2, is subtracted from the subtracted value data on the left side, which has been set to the register r1 to obtain a date-and-time gap between “03:48:21 on 25th of Jun. 2012” and “22:10:21 on 10th of Sep. 2010”.

In FIG. 7, (i) the comparison unit 402 compares the subtracted value data of the register r1 with the subtraction value data of the register r2 in a byte at once, and stores the comparison result in the leading 1-byte area of a register r3 by executing the SIMD COMPARE instruction. Here, when the right side is larger than the left side, a bit area that correspond to the byte position of the comparison target is set (turned ON) in the result byte (leading 1-byte area of the register r3), in accordance with an option of the SIMD COMPARE instruction.

In the example of FIG. 7, the right side is larger than the left side in the third byte, so that “1” is set to a bit area of the third bit that corresponds to the third byte in the leading 1-byte area of the register r3. In addition, the right side is larger than the left side in the fifth byte, so that “1” is set to a bit area of the fifth bit that corresponds to the fifth byte in the leading 1-byte area of the register r3. As a result, the digit positions 3 and 5 in which the right side is larger than the left side may be identified from among the digit positions 0 to 7.

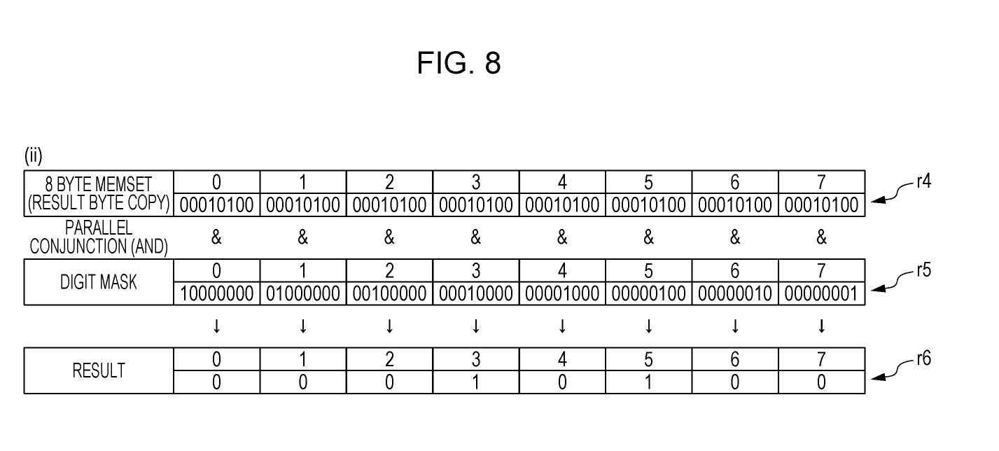

In FIG. 8, (ii) the generation unit 403 copies the result byte “00010100” of the leading 1-byte area of the register r3, and sets the result bytes “00010100” to a register r4 by an 8-byte portion. In the following description, data in which pieces of data having 1 byte (for example, result bytes) are set to a register r$ by an 8-byte portion may be referred to as “8-byte MEMSET data”.

In addition, the generation unit 403 obtains parallel conjunction (AND) between the 8-byte MEMSET data of the register r4 and a digit mask of a register r5, and stores the obtained result in a register r6. The digit mask is a bit mask that is used to take out a value of each of the digits in a byte. As a result, the result byte “00010100” having 1 byte may be increased to data of 8 bytes, which is compatible with the SIMD instruction. In the parallel conjunction (AND), “AND” is obtained in a byte.

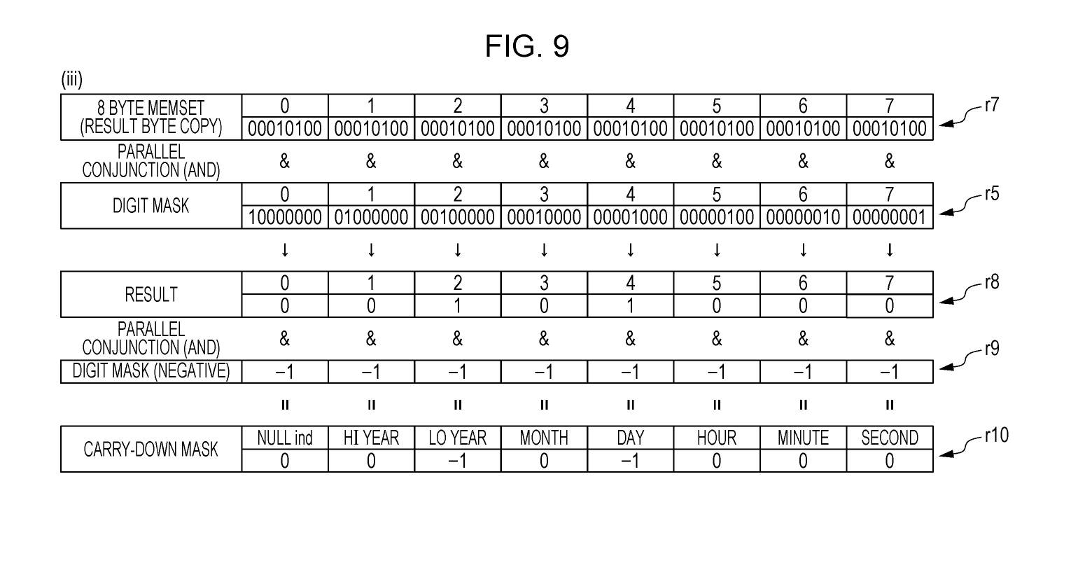

In FIG. 9, (iii) the generation unit 403 shifts the result byte “00010100” of the leading 1-byte area of the register r3, to the left by 1 bit. As a result, the result byte “00101000” may be generated that indicates a carry-down location in which carry-down occurs, with the subtraction of the right side from the left side. In addition, the generation unit 403 copies the result byte “00101000” of the leading 1-byte area of the register r3, and sets the result bytes “00101000” to a register r7 by an 8-byte portion.

After that, the generation unit 403 obtains parallel conjunction (AND) between the 8-byte MEMSET data of the register r7 and the digit mask of the register r5, and stores the obtained result in a register r8. As a result, the result byte “00101000” of 1 byte may be increased to data of 8 bytes, which is compatible with the SIMD instruction.

In addition, the generation unit 403 obtains parallel conjunction (AND) between the result of the register r8 and a digit mask (negative) of a register r9, and stores the obtained result in a register r10. The digit mask (negative) is a bit mask that is used to add a minus sign (−) to a value of in a byte. As a result, a carry-down mask may be generated that is used to subtract “1” from the value of the carry-down location. The carry-down mask of the register r10 corresponds to the above-described pieces of carry-down subtraction value data e0 to e7.

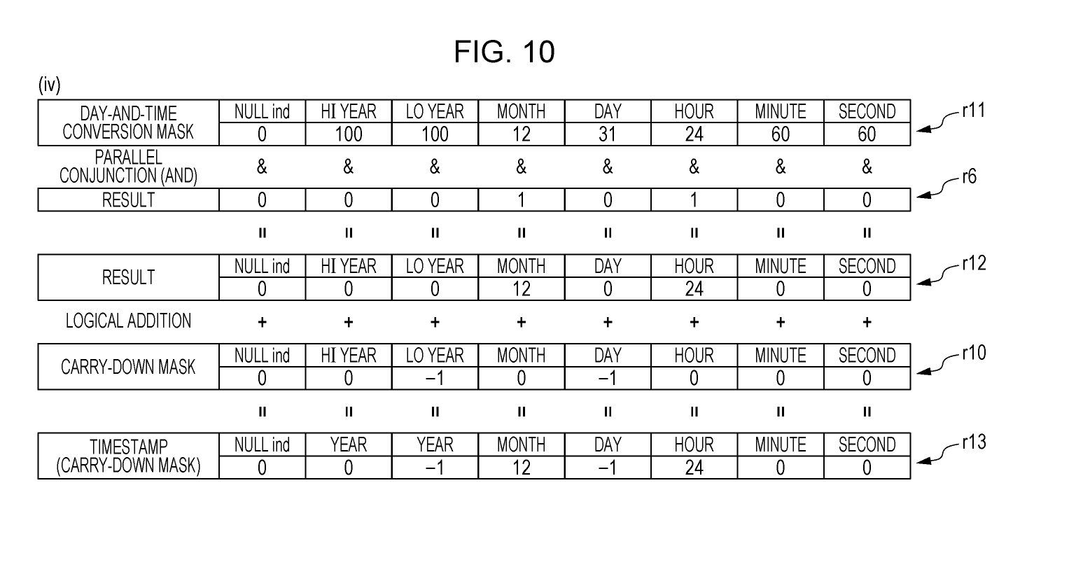

In FIG. 10, (iv) the generation unit 403 sets a date-and-time conversion mask that is compatible with TIMESTAMP-type data, to a register r11. The date-and-time conversion mask indicates the number of values that are to be obtained as the value of a digit position that corresponds to each field of the TIMESTAMP-type data, for the digit position. The date-and-time conversion mask is stored, for example, in the memory 302.

Here, the range of values to be obtained as the value of each of the digit positions 1 and 2 corresponding to “year” is “0 to 99”, and the number of values to be obtained as the value of each of the digit positions 1 and 2 is “100”. In addition, the range of values to be obtained as the value of the digit position 3 corresponding to “month” is “1 to 12”, and the number of values to be obtained as the value of the digit position 3 is “12”.

In addition, the range of values to be obtained as the value of the digit position 4 corresponding to “day” is “1 to 31”, and the number of values to be obtained as the value of the digit position 4 is “31”. In addition, the range of values to be obtained as the value of the digit position 5 corresponding to “hour” is “0 to 23”, and the number of values to be obtained as the value of the digit position 5 is “24”.

In addition, the range of values to be obtained as the value of the digit position 6 corresponding to “minute” is “0 to 59”, and the number of values to be obtained as the value of the digit position 6 is “60”. In addition, the range of values to be obtained as the value of the digit position 7 corresponding to “second” is “0 to 59”, and the number of values to be obtained as the value of the digit position 7 is “60”.

However, the number of values to be obtained as the value of the digit position 4 is switched depending on the value of the digit position 3 of the subtracted value data. For example, when the value of the digit position 3 of the subtracted value data is one of “1”, “3”, “5”, “7”, “8”, “10”, and “12”, the number of values to be obtained as the value of the digit position 4 is “31”. In addition, when the value of the digit position 3 of the subtracted value data is one of “4”, “6”, “9”, and “11”, the number of values to be obtained as the value of the digit position 4 is “30”.

In addition, when the value of the digit position 3 of the subtracted value data is “2”, the number of values to be obtained as the value of the digit position 4 is “28”. In addition, in a case where the year of the subtracted value data indicates a leap year, when the value of the digit position 3 of the subtracted value data is “2”, the number of values t to be obtained as the value of the digit position 4 is “29”. In addition, it is assumed that the number of values to be obtained as the value of the digit position 0 corresponding to “NULL ind” is “0”.

After that, the generation unit 403 obtains parallel conjunction (AND) between the date-and-time conversion mask of the register r11 and the result of the register r6, and stores the obtained result in a register r12. As a result, the data may be generated that is added to the digit position in which the right side is larger than the left side, with the carry-down. The result of the register r12 corresponds to the above-described pieces of carry-down addition value data d0 to d7.

In addition, the generation unit 403 combines the result of the register r12 and the carry-down mask of the register r10, and stores the combined result in a register r13. As a result, the carry-down value data may be generated that indicates a value that is to be added to the digit position in which the right side is larger than the left side and a value that is subtracted from the carry-down location. The result of the register r13 corresponds to the above-described pieces of carry-down value data c0 to c7.

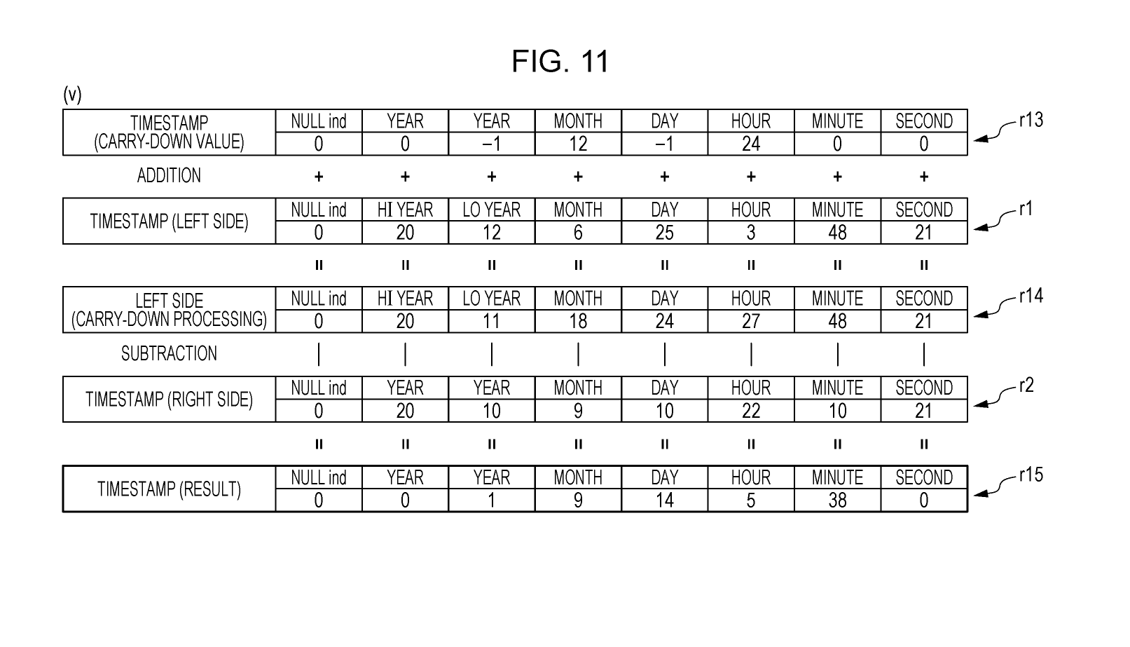

In FIG. 11, (v) the generation unit 403 combines the value of the carry-down value of the register r13 and the subtracted value data of the register r1, and stores the obtained result in a register r14. As a result, the subtracted value data for which carry-down processing is executed may be generated. The carry-down processing is processing in which addition to the digit position in which the right side is larger than the left side and subtraction from the carry-down location are executed.

In addition, the generation unit 403 subtracts the subtraction value data of the register r2 from the subtracted value data of the register r14, for which the carry-down processing has been executed, and stores the obtained result in a register r14. As a result, the date-and-time gap “1 year, 9 months, 14 days, 5 hours, 38 minutes, and 0 seconds” between “03:48:21 on 25th of Jun. 2012” and “22:10:21 on 10th of Sep. 2010” may be obtained.

### (Calculation Processing Example of TIME-Type Data)

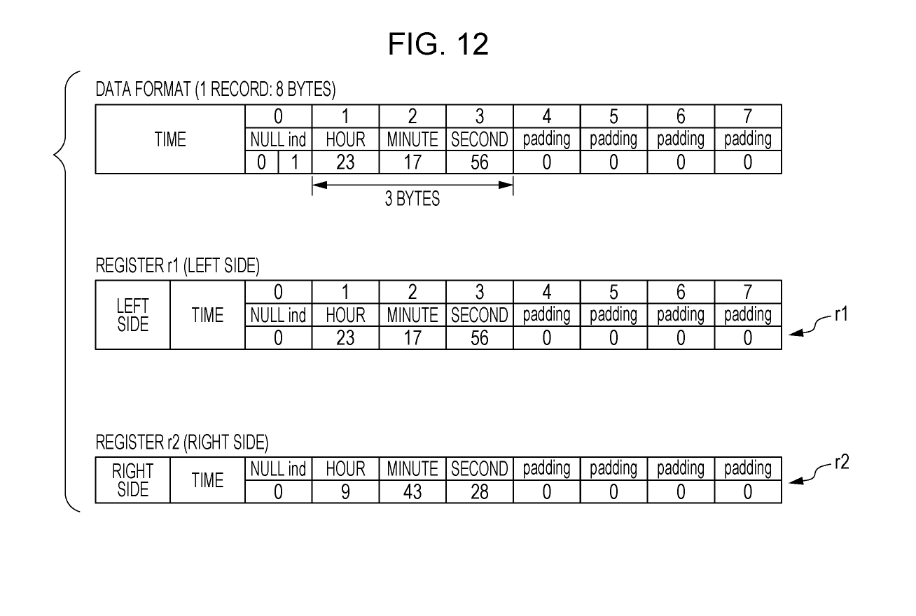

A calculation processing example of the database server 201 when the subtracted value data and the subtraction value data correspond to TIME-type data is described below with reference to FIGS. 12 to 17. First, the data format of TIME-type data when internal processing is executed in the database server 201 is described.

FIG. 12 is a diagram illustrating the data format of the TIME-type data. In FIG. 12, the TIME-type data includes fields of “NULL ind”, “hour”, “minute”, “second”, and four pieces of “padding”, and is data in which a single record is 8 bytes.

Here, the data of the 0th byte of the TIME-type data indicates “NULL ind”. The data of the first byte indicates “hour”. The data of the second byte indicates “minute”. The data of the third byte indicates “second”. The pieces of data of the fourth to seventh bytes indicate “padding”. Here, “padding” is meaningless data that is added to the TIME-type data, which is used to be compatible with the subtracted value data and the subtraction value data having the fixed length of 8 bytes.

In the database 220, each of “hour”, “minute”, and “second” of the TIME-type data is configured by the length in a byte, and the whole “hour”, “minute”, and “second” becomes 3 bytes. Here, in order to utilize the SIMD COMPARE instruction, an area on which the calculation is performed is caused to become 8 bytes. For example, the database server 201 performs the calculation by performing zero padding on 4 bytes on the right side of the portion excluding “NULL ind”, which makes up 8 bytes.

In the example of FIG. 12, as the subtracted value data of the TIME-type, a bit sequence that indicates “23:17:56” is set to the register r1. In addition, as the subtraction value data of the TIME-type, a bit sequence that indicates “09:43:28” is set to the register r2.

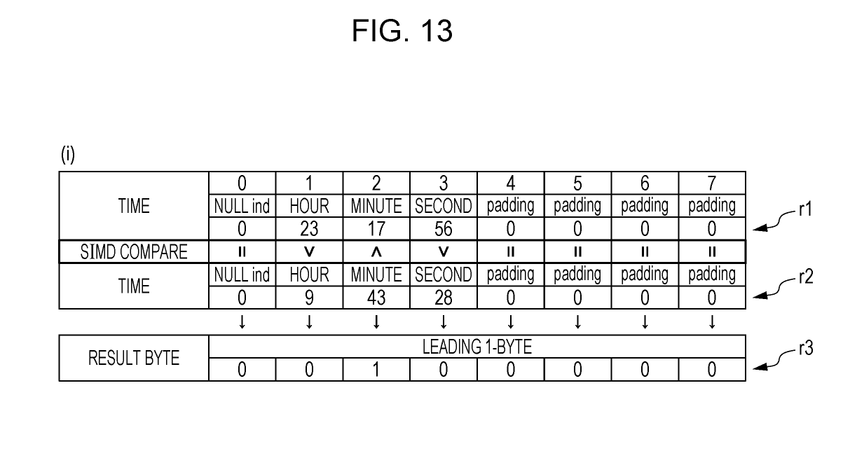

FIGS. 13 to 17 are diagrams illustrating a calculation processing example of TIME-type data. Here, it is assumed that the subtraction value data on the right side, which has been set to the register r2, is subtracted from the subtracted value data on the left side, which has been set to the register r1, and a time gap between “23:17:56” and “09:43:28” is obtained.

In FIG. 13, (i) the comparison unit 402 compares the subtracted value data of the register r1 with the subtraction value data of the register r2, in a byte, at once, and stores the obtained result in the leading 1-byte area of the register r3 by executing the SIMD COMPARE instruction.

In the example of FIG. 13, the right side is larger than the left side in the second byte, so that “1” is set to a bit area of the second bit that corresponds to the second byte in the leading 1-byte area of the register r3. As a result, the digit position 2 in which the right side is larger than the left side may be identified from among the digit positions 0 to 7.

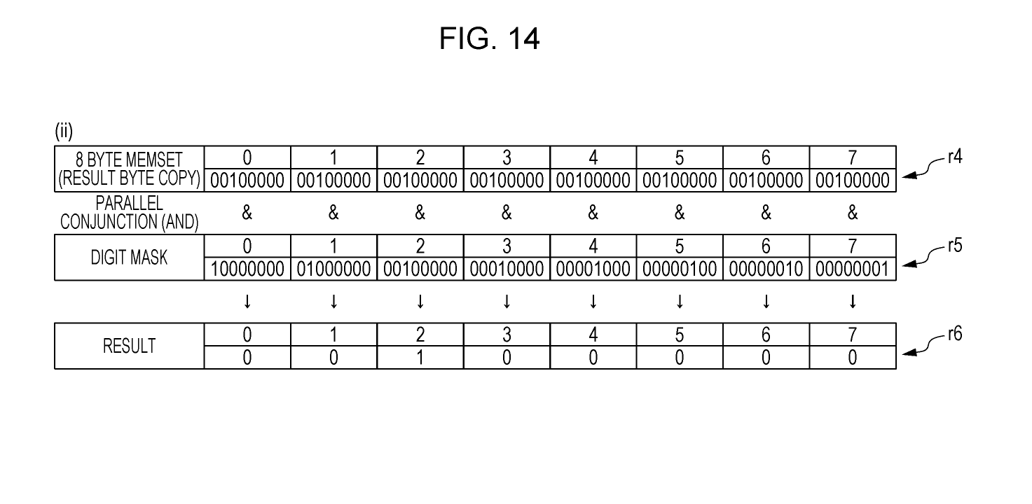

In FIG. 14, (ii) the generation unit 403 copies the result byte “00100000” of the leading 1-byte area of the register r3, and sets the result bytes “00100000” to the register r4 by an 8-byte portion. In addition, the generation unit 403 obtains parallel conjunction (AND) between the 8-byte MEMSET data of the register r4 and the digit mask of the register r5, and stores the obtained result in the register r6. As a result, the result byte “00100000” of 1 byte may be increased to data of 8 bytes, which is compatible with the SIMD instruction.

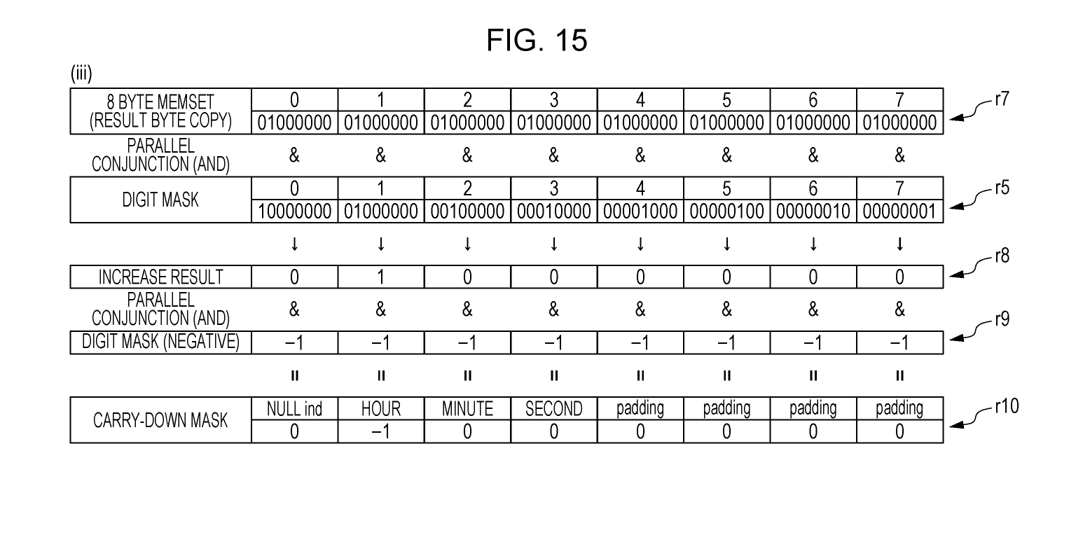

In FIG. 15, (iii) the generation unit 403 shifts the result byte “00100000” of the leading 1-byte area of the register r3 to the left by 1 bit. As a result, the result byte “01000000” may be generated that indicates the carry-down location in which the carry-down occurs, with the subtraction of the right side from the left side. In addition, the generation unit 403 copies the result byte “01000000” of the leading 1-byte area of the register r3, and sets the result bytes “01000000” to the register r7 by an 8-byte portion.

After that, the generation unit 403 obtains parallel conjunction (AND) between the 8-byte MEMSET data of the register r7 and the digit mask of the register r5, and stores the obtained result in the register r8. As a result, the result byte “01000000” of 1 byte may be increased to data of 8 bytes, which is compatible with the SIMD instruction.

In addition, the generation unit 403 obtains parallel conjunction (AND) between the increase result of the register r8 and the digit mask (negative) of the register r9, and stores the obtained result in the register r10. As a result, a carry-down mask that is used to subtract “1” from the value of the carry-down location may be generated. The carry-down mask of the register r10 corresponds to the above-described pieces of carry-down subtraction value data e0 to e7.

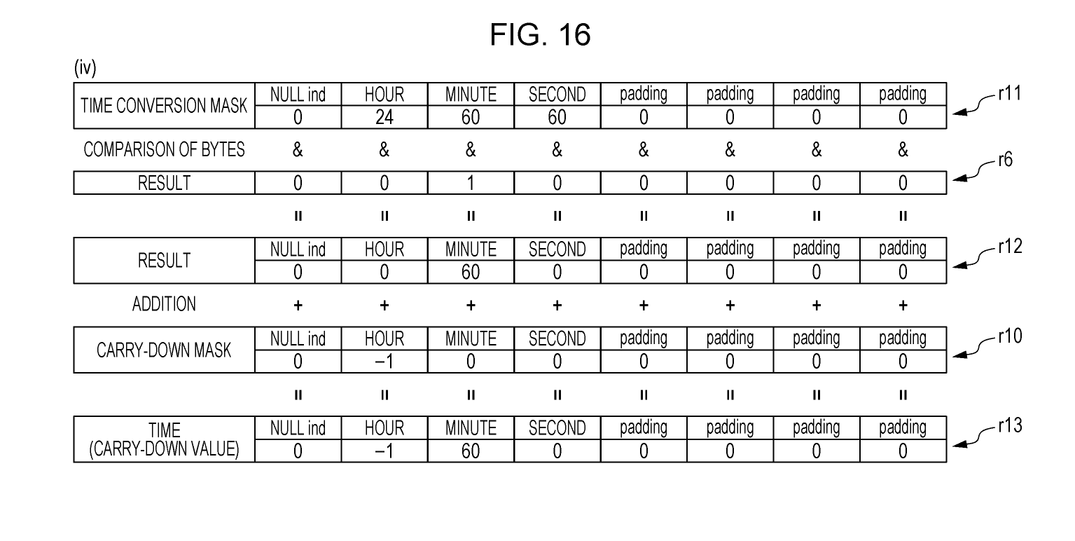

In FIG. 16, (iv) the generation unit 403 sets a time conversion mask that corresponds to the TIME-type data, to the register r11. The time conversion mask indicates the number of values to be obtained as the value of a digit position corresponding to each of the fields of the TIME-type data, for each of the digit positions. The time conversion mask is stored, for example, in the memory 302.

Here, the range of values to be obtained as the value of the digit position 1 corresponding to “hour” is “0 to 23”, and the number of values to be obtained as the value of the digit position 1 is “24”. In addition, the range of values to be obtained as the value of the digit position 2 correspondings to “minute” is “0 to 59”, and the number of values to be obtained as the value of the digit position 2 is “60”. In addition, the range of values to be obtained as the value of the digit position 3 corresponding to “second” is “0 to 59”, and the number of values to be obtained as the value of the digit position 3 is “60”.

However, it is assumed that the number of values to be obtained as the value of the digit position 0 corresponding to “NULL ind” is “0”. Similarly, the number of values to be obtained as the value of each of the digit positions 4 to 7 corresponding to “padding” is “0”.

After that, the generation unit 403 obtains parallel conjunction (AND) between the time conversion mask of the register r11 and the result of the register r6, and stores the obtained result in the register r12. As a result, the data may be generated that indicates a value that is added to a digit position in which the right side is larger than the left side, with the carry-down. The result of the register r12 corresponds to the above-described pieces of carry-down addition value data d0 to d7.

In addition, the generation unit 403 combines the result of the register r12 and the carry-down mask of the register r10, and stores the obtained result in the register r13. As a result, the data of a carry-down value may be generated that indicates a value that is added to a digit position in which the right side is larger than the left side and a value that is subtracted from the carry-down location. The result of the register r13 corresponds to the above-described pieces of carry-down value data c0 to c7.

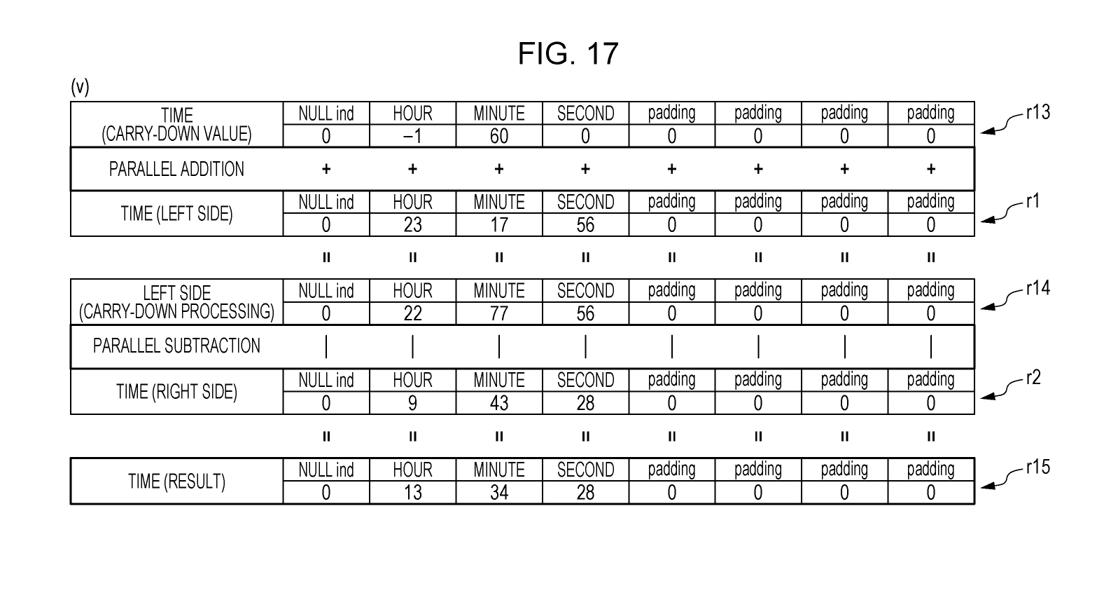

In FIG. 17, (v) the generation unit 403 combines the data of the carry-down value of the register r13 and the subtracted value data of the register r1, and stores the obtained result in the register r14. As a result, the subtracted value data for which the carry-down processing has been executed may be generated.

In addition, the generation unit 403 subtracts the subtraction value data of the register r2 from the subtracted value data of the register r14, for which the carry-down processing has been executed, and stores the obtained result in the register r15. As a result, a time gap “13 hours, 34 minutes, and 28 seconds” between “23:17:56” and “09:43:28” may be obtained.

### (Calculation Processing Example of DATE-Type Data)

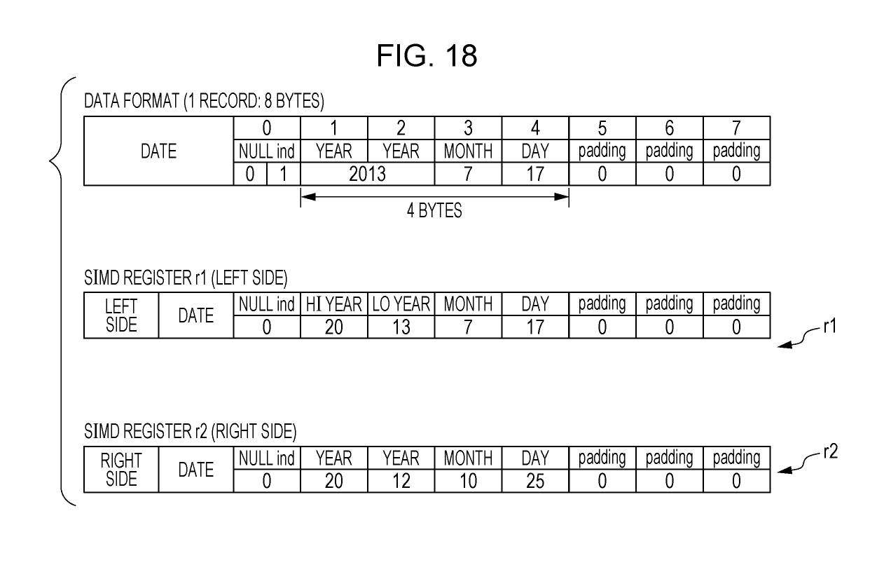

A calculation processing example of the database server 201 when the subtracted value data and the subtraction value data correspond to DATE-type data is described below with reference to FIGS. 18 to 23. First, the data format of DATE-type data when internal processing is executed in the database server 201 is described.

FIG. 18 is a diagram illustrating the data format of the DATE-type data. In FIG. 18, the DATE-type data includes fields of “NULL ind”, “HI year”, “LO year”, “month”, “day”, and 3 pieces of “padding”, and is data in which a single record is 8 bytes.

Here, the data of the 0th byte of the DATE-type data indicates “NULL ind”. The data of the first byte indicates “HI year”. The data of the second byte indicates “LO year”. The data of the third byte indicates “month”. The data of the fourth byte indicates “day”. The pieces of data of the fifth to seventh bytes indicate “padding”.

In the database 220, the DATE-type data is configured by 2 bytes of “year”, 1 byte of “month”, and 1 byte of “day”, and the whole DATE-type data has 4 bytes. Here, in order to utilize the SIMD COMPARE instruction, the area on which the calculation is performed is caused to be 8 bytes. For example, the database server 201 performs the calculation by performing zero padding on 3 bytes of the right side of the portion excluding “NULL ind”, which makes up 8 bytes.

In the example of FIG. 18, as the subtracted value data of the DATE-type, a bit sequence that indicates “17th of Jul. 2013” is set to the register r1. In addition, as the subtraction value data of the DATE-type, a bit sequence that indicates “25th of Oct. 2012” is set to the register r2.

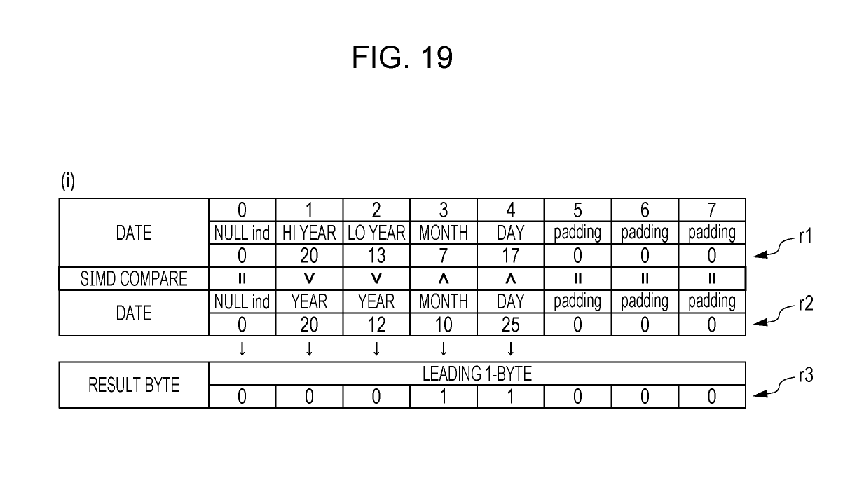

FIGS. 19 to 23 are diagrams illustrating a calculation processing example of the DATE-type data. Here, it is assumed that the subtraction value data on the right side, which has been set to register r2, is subtracted from the subtracted value data on the left side, which has been set to the register r1, and an time gap between “17th of Jul. 2013” and “25th of Oct. 2012” is obtained.

In the FIG. 19, (i) the comparison unit 402 compares the subtracted value data of the register r1 with the subtraction value data of the register r2, in a byte at once, and stores the obtained result in the leading 1-byte area of the register r3, by executing the SIMD COMPARE instruction.

In the example of FIG. 19, the right side is larger than the left side in the three and fourth bytes, so that “1” is set to bit areas of the third and fourth bits that correspond to the third and fourth bytes in the leading 1-byte area of the register r3. As a result, the digit positions 3 and 4 in which the right side is larger than the left side may be identified from among the digit positions 0 to 7.

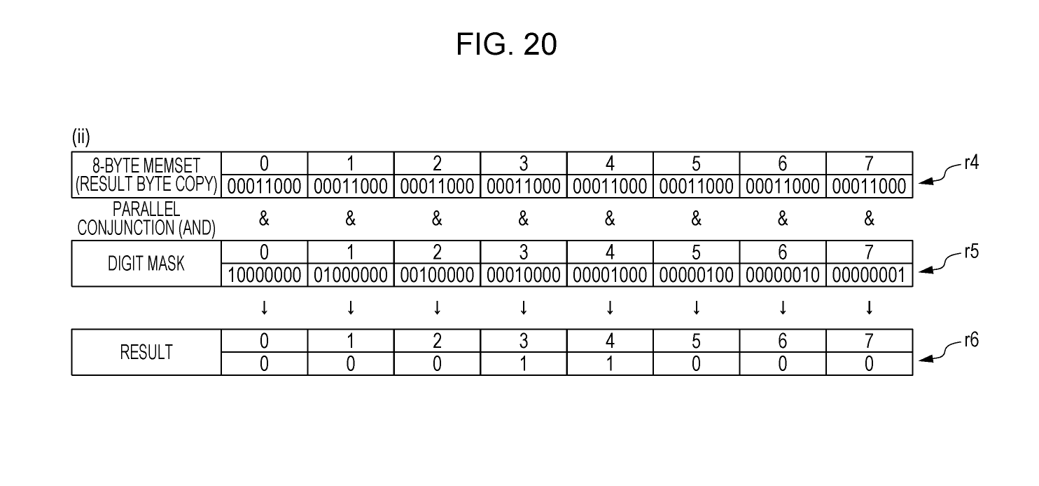

In FIG. 20, (ii) the generation unit 403 copies the result byte “00011000” of the leading 1-byte area of the register r3, and sets the result bytes “00011000” to the register r4 by an 8-byte portion. In addition, the generation unit 403 obtains parallel conjunction (AND) between the 8-byte MEMSET data of the register r4 and the digit mask of the register r5, and stores the obtained result in the register r6. As a result, the result byte “00011000” of 1 byte may be increased to data of 8 bytes, which is compatible with the SIMD instruction.

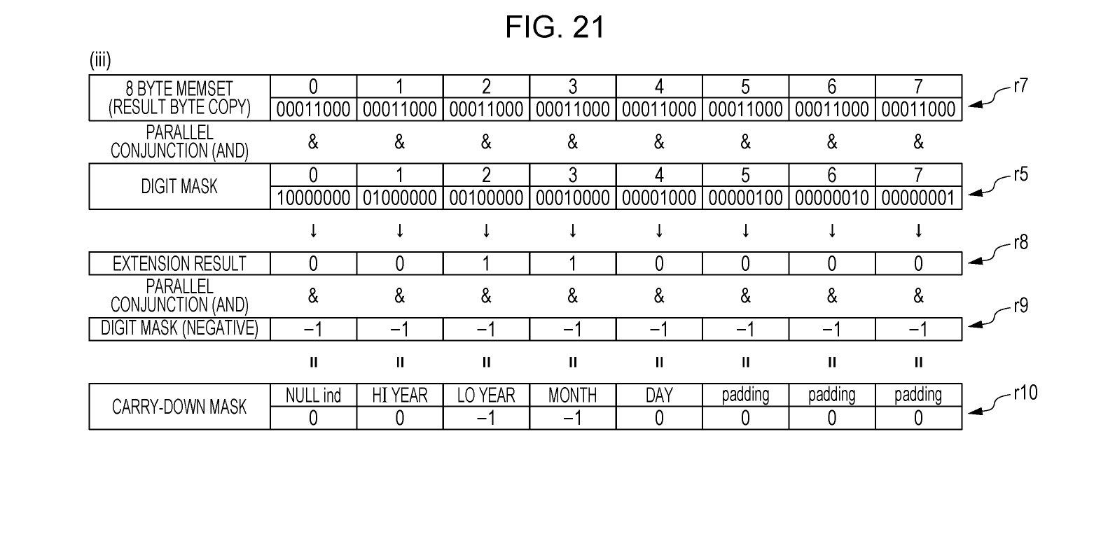

In FIG. 21, (iii) the generation unit 403 shifts the result byte “00011000” of the leading 1-byte area of the register r3, to the left by 1 bit. As a result, the result byte “00110000” may be generated that indicates the carry-down location in which the carry-down occurs, with the subtraction of the right side from the left side. In addition, the generation unit 403 copies the result byte “00110000” of the leading 1-byte area of the register r3, and sets the result bytes “00110000” to the register r7 by an 8-byte portion.

After that, the generation unit 403 obtains parallel conjunction (AND) between the 8-byte MEMSET data of the register r7 and the digit mask of the register r5, and stores the obtained result in the register r8. As a result, the result byte “00110000” of 1 byte may be increased to data of 8 bytes, which is compatible with the SIMD instruction.

In addition, the generation unit 403 obtains parallel conjunction (AND) between the increase result of the register r8 and the digit mask (negative) of the register r9, and stores the obtained result in the register r10. As a result, the carry-down mask may be generated that is used to subtract “1” from the value of the carry-down location. The carry-down mask of the register r10 corresponds to the above-described pieces of carry-down subtraction value data e0 to e7.

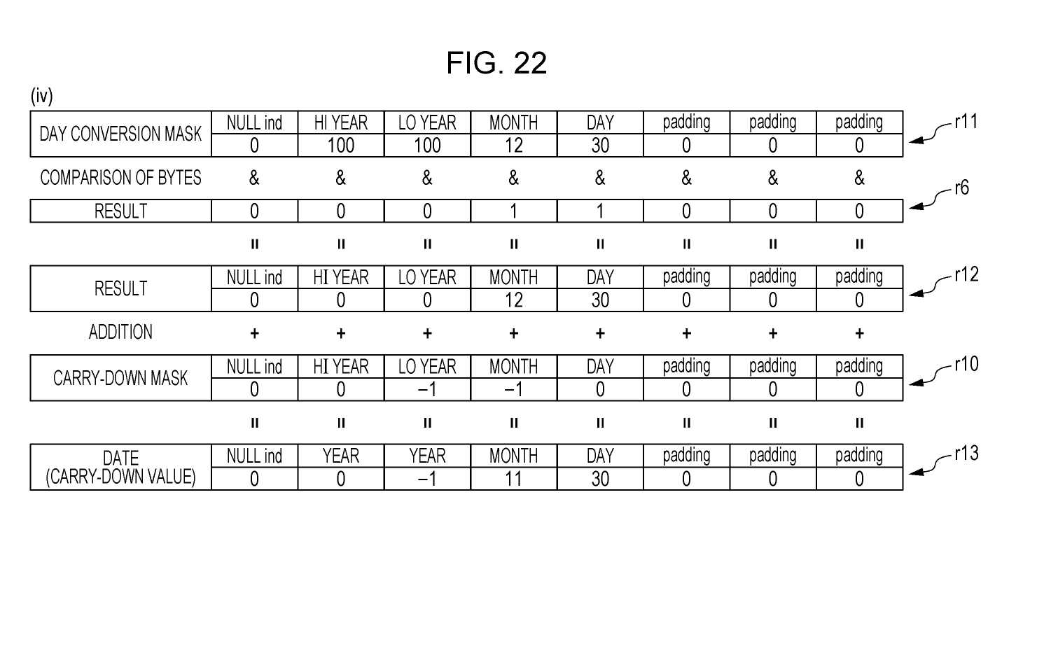

In FIG. 22, (iv) the generation unit 403 sets a date conversion mask that corresponds to the DATE-type data, to the register r11. The date conversion mask indicates the number of values that are to be obtained as the value of a digit position that corresponds to each of the fields of the DATE-type data, for each of the digit positions. The date-and-time conversion mask is stored, for example, in the memory 302.

Here, the range of values to be obtained as the value of each of the digit positions 1 and 2 corresponding to “year” is “0 to 99”, and the number of values to be obtained as the value of each of the digit positions 1 and 2 is “100”. In addition, the range of values to be obtained as the value of the digit position 3 corresponding to “month” is “1 to 12”, and the number of values to be obtained as the value of the digit position 3 is “12”.

In addition, the range of values to be obtained as the value of the digit position 4 corresponding to “day” is “1 to 31”, and the number of values to be obtained as the value of the digit position 4 is “31”. However, it is assumed that the number of values that are to be obtained as the value of the digit position 0 corresponding to “NULL ind” is “0”. Similarly, it is assumed that the number of values to be obtained as the value of each of the digit positions 5 to 7 corresponding to “padding” is “0”.

After that, the generation unit 403 obtains parallel conjunction (AND) between the date conversion mask of the register r11 and the result of the register r6, and stores the obtained result in the register r12. As a result, the data may be generated that indicates that the value that is added to the digit position in which the right side is larger than the left side, with the carry-down. The result of the register r12 corresponds to the above-described pieces of carry-down addition value data d0 to d7.

In addition, the generation unit 403 combines the result of the register r12 and the carry-down mask of the register r10, and stores the obtained result in the register r13. As a result, the data of the carry-down value may be generated that indicates the value that is added to the digit position in which the right side is larger than the left side, and the value that is subtracted from the carry-down location. The result of the register r13 corresponds to the above-described pieces of carry-down value data c0 to c7.

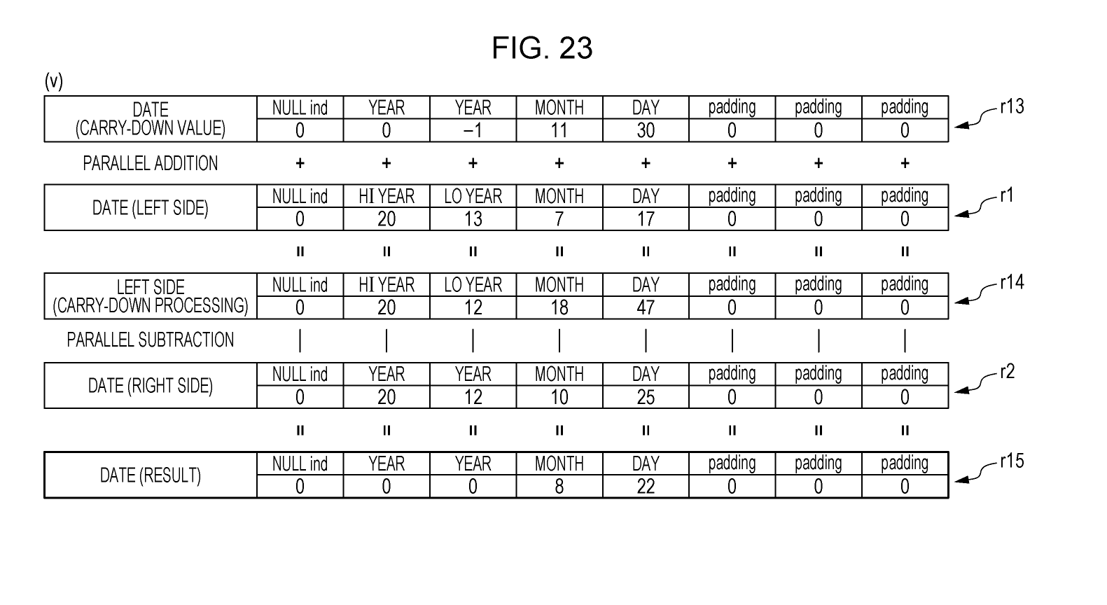

In FIG. 23, (v) the generation unit 403 combines the data of the carry-down value of the register r13 and the subtracted value data of the register r1, and stores the obtained result in the register r14. As a result, the subtracted value data for which the carry-down processing has been executed may be generated.

In addition, the generation unit 403 subtracts the subtraction value data of the register r2 from the subtracted value data of the register r14, for which the carry-down processing has been executed, and stores the obtained result in the register r15. As a result, a time gap “8 months, and 22 days” between “17th of Jul. 2013” and “25th of Oct. 2012” may be obtained.

### (Calculation Processing Procedure of the Database Server 201)

A calculation processing procedure of the database server 201 is described below. Here, a case in which the subtracted value data and the subtraction value data correspond to TIMESTAMP-type data is described as an example.

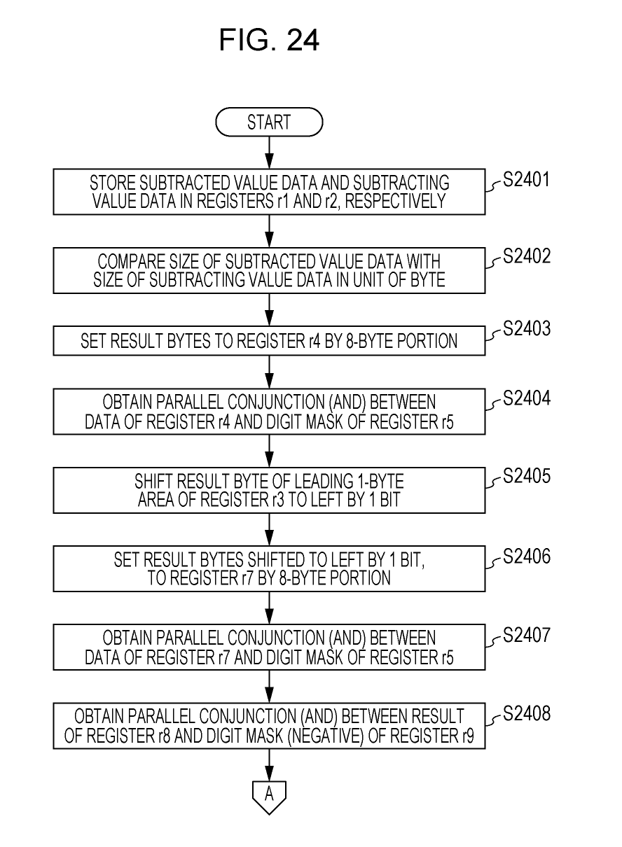

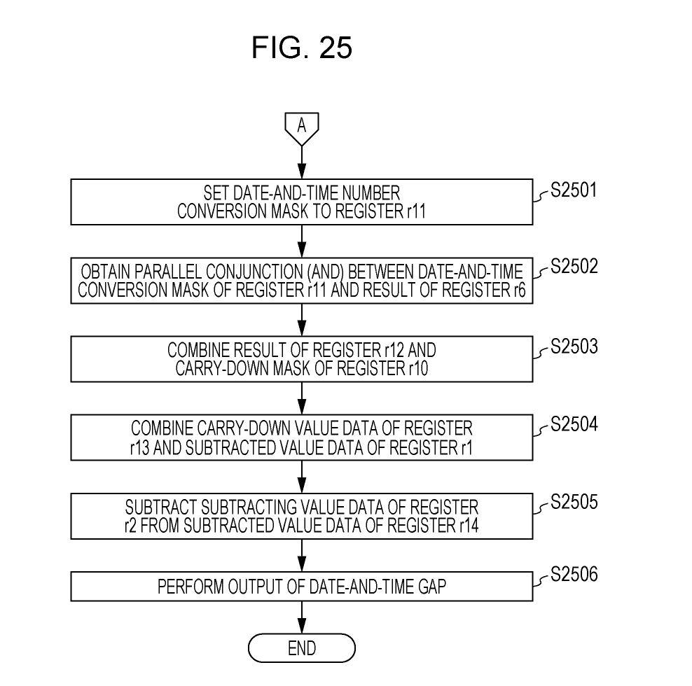

FIGS. 24 and 25 are flowcharts illustrating an example of the calculation processing procedure of the database server 201. In the flowchart of FIG. 24, first, the database server 201 respectively stores the subtracted value data and the subtraction value data in the registers r1 and r2 (Step S2401).

After that, the database server 201 compares the size of the subtracted value data of the register r1 with the size of the subtraction value data of the register r2, in a byte, at once, and stores the obtained result in the leading 1-byte area of the register r3, by the SIMD COMPARE instruction (Step S2402).

For example, the database server 201 sets “ON (1)” to a bit area (digit) that corresponds to the byte position in which the right side is larger than the left side, in the leading 1-byte area of the register r3. In addition, the database server 201 sets “OFF (0)” to a bit area (digit) that corresponds to the byte position in which the left side is larger or equal to the right side, in the leading 1-byte area of the register r3.

After that, the database server 201 copies the result byte of the leading 1-byte area of the register r3, and sets the result bytes to the register r4 by an 8-byte portion (Step S2403). In addition, the database server 201 obtains parallel conjunction (AND) between the data of the register r4 (8-byte MEMSET data) and the digit mask of the register r5, and stores the obtained result in the register r6 (Step S2404).

For example, the database server 201 sets “ON (1)” to a byte area (digit) that corresponds to the byte position in which one of the values of the register r4 and the corresponding value of the register r5 are matched with each other. In addition, the database server 201 sets “OFF (0)” to a byte area (digit) that corresponds to the byte position in which one of the values of the register r4 and the corresponding value of the register r5 are not matched with each other.

After that, the database server 201 shifts the result byte of the leading 1-byte area of the register r3, to the left by 1 bit (Step S2405). In addition, the database server 201 copies the result byte that has been shifted to the left by 1 bit, and sets the result bytes to the register r7, by an 8-byte portion (Step S2406).

After that, the database server 201 obtains parallel conjunction (AND) between the data of the register r7 (8-byte MEMSET data) and the digit mask of the register r5, and stores the obtained result in the register r8 (Step S2407).

After that, the database server 201 obtains parallel conjunction (AND) between the result of the register r8 and the digit mask (negative) of the register r9, and stores the obtained result in the register r10 (Step S2408), and the flow proceeds to Step S2501 illustrated in FIG. 25.

In the flowchart of FIG. 25, first, the database server 201 sets a date-and-time conversion mask that is compatible with TIMESTAMP-type data, to the register r11 (Step S2501). In addition, the database server 201 obtains parallel conjunction (AND) between the date-and-time conversion mask of the register r11 and the result of the register r6, and stores the obtained result in the register r12 (Step S2502).

After that, the database server 201 combines the result of the register r12 and the carry-down mask of the register r10, and stores the obtained result in the register r13 (Step S2503). In addition, the database server 201 combines the carry-down value data of the register r13 and the subtracted value data of the register r1, and stores the obtained result in the register r14 (Step S2504).

After that, the database server 201 subtracts the subtraction value data of the register r2, from the subtracted value data of the register r14, for which the carry-down processing has been executed, and stores the obtained result in the register r15 (Step S2505). In addition, the database server 201 performs output of the result of the register r15, as data that indicates the date-and-time gap (Step S2506), and a series of the pieces of processing in the flowchart ends.

As a result, the date-and-time gap between the date that is indicated by the subtracted value data and the data that is indicated by the subtraction value data may be obtained.

As described above, in the database server 201 according to the embodiment, the size comparison of the data a# (divided pieces of subtracted value data) and the data b# (divided pieces of subtraction value data) that have the corresponding digit positions # may be performed at once by the SIMD COMPARE instruction. As a result, the number of processing steps that is desired for the size comparison of the digit positions of the pieces of data that indicate a date and time may be reduced to “1”.

In addition, in the database server 201, the carry-down addition value data d# may be generated that is used to add the number of values that are to be obtained as the value of a digit position # in which the data b# is larger than the data a#, to the value of the digit position # by the parallel processing instruction. As a result, the data may be efficiently generated that indicates the value that is added to each of the digit positions with the carry-down.

In addition, in the database server 201, the carry-down subtraction value data e# may be generated that is used to subtract “1” from the value of the digit position # of the carry-down location, by the parallel processing instruction. As a result, the data may be efficiently generated that indicates the value that is subtracted from each of the digit positions with the carry-down.

In addition, in the database server 201, the carry-down value data c# may be generated by combining the carry-down addition value data d# and the carry-down subtraction value data e# that have the corresponding digit position # by the parallel processing instruction. As a result, the data may be efficiently generated that indicates the value that is added to and subtracted from each of the digit positions, with the carry-down.

In addition, in the database server 201, the carry-down value data c# may be added to the data a# having the corresponding digit position # by the parallel processing instruction. As a result, the subtracted value data for which the carry-down processing has been executed may be efficiently generated.

In addition, in the database server 201, the data b# may be subtracted from the data a# to which the carry-down value data c# has been added, and which has the corresponding digit position #, by the parallel processing instruction. As a result, the data may be efficiently generated that indicates a time gap between the date and time that is indicated by the subtraction value data and the date and time that is indicated by the subtracted value data for which the carry-down processing has been executed.

Therefore, in the database server 201, the speed-up of the subtraction processing of data in which the range of values that are to be obtained is different depending on a digit position such as the TIMESTAMP-type data, the TIME-type data, and the DATE-type data may be achieved.

For example, when the size comparison is repeatedly performed for each digit position of the TIMESTAMP-type data, and subtraction and addition with the carry-down are repeatedly performed, 42 steps (subtraction: 6 steps, steps other than the subtraction: 36 steps) are desired in total. On the contrary, in the database server 201, the number of processing steps that are desired for the subtraction of the TIMESTAMP-type data may be reduced to 11 steps in total (comparison at once: 1 step, carry-down at once: 9 steps, subtraction at once: 1 step), so that the improvement of the processing performance may be achieved.

In the description, as the data formats of various data-types when the internal processing is executed in the database server 201, the case in which the subtracted value data and the subtraction value data correspond to 8 bytes is described above as an example, but the embodiment is not limited to the case. For example, the subtracted value data and the subtraction value data may correspond to 16 bytes or 32 bytes so as to be matched with the bit length of data (for example, 16 bytes or 32 bytes) that is processed by a single instruction.

In addition, in the description, the case in which each of the subtracted value data and the subtraction value data are divided in a byte is described as an example, but the embodiment is not limited to such a case. For example, each of the subtracted value data and the subtraction value data may be divided in a unit of 2 bytes or a unit of 3 bytes so as to be compatible with a unit of processing of an instruction (for example, 2 bytes or 3 bytes), in which a plurality of pieces of data is processed by a single instruction.

The calculation method that is described in the embodiment may be achieved by executing a program that has been prepared beforehand, in a computer such as a personal computer or a workstation. The calculation program is recorded to a computer-readable recording medium such as a hardware disk, a flexible disk, a compact disc-read-only memory (CD-ROM), a magneto-optical (MO), a digital versatile disc (DVD), or the like, and executed so as to be read from the recording medium by the computer. In addition, the calculation program may be distributed through a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a calculation program that causes a computer to execute a process, the process comprising:
dividing each of subtracted value data and subtraction value data into a plurality pieces of data in a byte;
comparing sizes of each of the divided pieces of subtracted value data and each of the divided pieces of subtraction value data, which have a corresponding digit position;
adding carry-down value data that is obtained from digit information of each of the divided pieces of subtracted value data, to the divided corresponding piece of subtracted value data, in accordance with a comparison result; and
subtracting each of the divided pieces of subtraction value data, from the divided piece of subtracted value data, to which the carry-down value data is add, and which has the corresponding digit position.

2. A non-transitory computer-readable recording medium having stored therein the calculation program according to claim 1, wherein
the process that is executed by the computer further includes generating carry-down value data that is used to add a number of values that are to be obtained as a value of a digit position in which each of the divided pieces of subtraction value data is large as compared with the divided corresponding piece of subtracted value data, to the value of the digit position, depending on the digit position, and subtract 1 from a value of a higher digit position that is adjacent to the digit position, and
in the addition processing, the generated carry-down value data is added to the divided piece of subtracted value data, which has the corresponding digit position.

3. A non-transitory computer-readable recording medium having stored therein the calculation program according to claim 2, wherein
the process that is executed by the computer further includes generating carry-down addition value data that is used to add the number of values that are to be obtained as the value of the digit position in which each of the divided pieces of subtraction value data is large as compared with the divided corresponding piece of subtracted value data, to the value of the digit position, depending on the digit position, and generating carry-down subtraction value data that is used to subtract 1 from the value of the higher digit position that is adjacent to the digit position in which each of the divided pieces of subtraction value data is large as compared with the divided corresponding piece of subtracted value data, depending on the digit position, and
in the generation processing of the carry-down value data, the carry-down value data is generated by combining the carry-down addition value data and the carry-down subtraction value data that have the corresponding digit position.

4. A non-transitory computer-readable recording medium having stored therein the calculation program according to claim 1, wherein
each of the subtracted value data and the subtraction value data is TIMESTAMP-type data in which pieces of data that respectively indicate year, month, day, hour, minute, and second are arranged in a byte.

5. A non-transitory computer-readable recording medium having stored therein the calculation program according to claim 1, wherein
each of the subtracted value data and the subtraction value data is TIME-type data in which pieces of data that respectively indicate hour, minute, and second are arranged in a byte.

6. A non-transitory computer-readable recording medium having stored therein the calculation program according to claim 1, wherein
each of the subtracted value data and the subtraction value data is DATE-type data in which pieces of data that respectively indicate year, month, and day are arranged in a byte.

7. A calculation device comprising:
a comparison unit that divides each of subtracted value data and subtraction value data into a plurality pieces of data in a byte, and compares sizes of each of the divided pieces of subtracted value data and each of the divided pieces of subtraction value data, which have a corresponding digit position; and
a calculation unit that adds carry-down value data that is obtained from digit information of each of the divided pieces of subtracted value data, to the divided corresponding piece of subtracted value data, in accordance with comparison result, and subtracts each of the divided pieces of subtraction value data, from the divided piece of subtracted value data, to which the carry-down value data is add, and which has the corresponding digit position.

8. A calculation method for causing a computer to execute a process, the process comprising:
dividing each of subtracted value data and subtraction value data into a plurality pieces of data in a byte;
comparing sizes of each of the divided pieces of subtracted value data and each of the divided pieces of subtraction value data, which have a corresponding digit position;
adding carry-down value data that is obtained from digit information of each of the divided pieces of subtracted value data, to the divided corresponding piece of subtracted value data, in accordance with a comparison result; and
subtracting each of the divided pieces of subtraction value data, from the divided piece of subtracted value data, to which the carry-down value data is add, and which has the corresponding digit position.
